(19) United States
(12) Patent Application Publication
(10) Pub. No.: US 2026/0008126 A1
(43) Pub. Date: Jan. 8, 2026

(54) LASER CRYSTALLIZATION APPARATUS

(71) Applicant: Samsung Display Co., LTD., Yongin-si (KR)

(72) Inventors: DONG-MIN LEE, Yongin-si (KR); JI-HWAN KIM, Yongin-si (KR); JONGOH SEO, Yongin-si (KR); DONGGYU JIN, Yongin-si (KR)

(21) Appl. No.: 19/061,600

(22) Filed: Feb. 24, 2025

(30) Foreign Application Priority Data
Jul. 3, 2024 (KR) 10-2024-0087501

(51) Int. Cl. B23K 26/34; C01B 33/02

(52) U.S. Cl. CPC B23K 26/34; C01B 33/02

(57) ABSTRACT

A laser crystallization apparatus includes a laser irradiation part which radiates a first laser beam to a substrate, a laser controller which receives a second laser beam, where the laser controller includes a first lens having a first focal length and a second lens having a second focal length different from the first focal length, and the laser controller radiates a third laser beam, where the second laser beam is the first beam reflected from the substrate, and the third laser beam is the second laser beam passed through the laser controller, where an intensity of the second laser beam is adjusted by the laser controller.

This application claims priority to Korean Patent Application No. 10-2024-0087501, filed on Jul. 3, 2024, and all the benefits accruing therefrom under 35 U.S.C. § 119, the content of which in its entirety is herein incorporated by reference.

### BACKGROUND

### (1) Field

Embodiments of the invention relate generally to a laser crystallization apparatus.

### (2) Description of the Related Art

A display device may include a transistor and a light emitting diode connected to the transistor. The transistor transmits a driving current to the light emitting diode and includes an active pattern, a gate electrode, a source electrode, and a drain electrode.

The active pattern may be formed of polycrystalline silicon, an oxide semiconductor, etc., and the polycrystalline silicon may be formed by crystallizing an amorphous silicon. As a process for crystallizing the amorphous silicon into the polycrystalline silicon, an excimer laser annealing process, a solid phase crystallization process, a rapid thermal annealing process, etc. may be used.

For example, the excimer laser annealing process may be performed through a laser crystallization apparatus, and the laser crystallization apparatus radiates an excimer laser to a substrate. The temperature of an amorphous silicon layer on the substrate is increased by the excimer laser, and then decreased again, and the process is repeated, such that the amorphous silicon is melted and recrystallized.

### SUMMARY

Embodiments provide a laser crystallization apparatus.

A laser crystallization apparatus according to an embodiment includes a laser irradiation part which radiates a first laser beam to a substrate, and a laser controller which receives a second laser beam, where the laser controller includes a first lens having a first focal length and a second lens having a second focal length different from the first focal length, and the laser controller radiates a third laser beam. In such an embodiment, the second laser beam is the first beam reflected from the substrate, and the third laser beam is the second laser beam passed through the laser controller, where an intensity of the second laser beam is adjusted by the laser controller.

In an embodiment, an intensity of the third laser beam may be substantially the same as an intensity of the first laser beam.

In an embodiment, a ratio between the first focal length and the second focal length may correspond to a ratio between the intensity of the second laser beam and an intensity of the third laser beam.

In an embodiment, the first focal length may be greater than the second focal length.

In an embodiment, a ratio of the second focal length to the first focal length may be in a range of about 0.5 to about 0.6.

In an embodiment, an intensity of the second laser beam may be less than an intensity of the third laser beam.

In an embodiment, a ratio of an intensity of the second laser beam to an intensity of the third laser beam may be in a range of about 0.5 to about 0.6.

In an embodiment, a beam width of the second laser beam may be greater than a beam width of the third laser beam.

In an embodiment, a ratio of the beam width of the third laser beam to the beam width of the second laser beam may be in a range of about 0.5 to about 0.6.

In an embodiment, a first curvature radius of the first lens may be greater than a second curvature radius of the second lens.

In an embodiment, the first laser beam and the third laser beam may not intersect each other.

In an embodiment, each of the first lens and the second lens may be a telescope lens.

In an embodiment, the laser controller may further include a first mirror and a second mirror which reflect the second laser beam.

In an embodiment, a laser beam may sequentially travel through the first lens, the first mirror, the second lens, and the second mirror.

In an embodiment, a laser beam may sequentially travel through the first lens, the second lens, the first mirror, and the second mirror.

In an embodiment, a laser beam may sequentially travel through the first mirror, the first lens, the second lens, and the second mirror.

In an embodiment, a laser beam may sequentially travel through the first mirror, the first lens, the second mirror, and the second lens.

In an embodiment, the first laser beam may crystallize an amorphous silicon layer disposed on the substrate.

Therefore, a laser crystallization apparatus according to embodiments of the invention may include a laser irradiation part and a laser controller. The laser controller may control a laser beam to re-incidentally radiate the laser beam onto the substrate. Accordingly, the number of overlapping times in which the laser beam is radiated onto the substrate may increase, and the energy margin of the laser beam may be secured.

In such embodiments, the laser controller may reduce the beam width of the laser beam, thereby increasing the intensity of the laser beam. For example, the intensity of the laser beam radiated from the laser controller may be substantially the same as the intensity of the laser beam radiated from the laser irradiation part. As the laser controller increases the intensity of the re-incident laser beam, the streak defect existing in the polycrystalline silicon layer may be removed. Accordingly, the reliability of the polycrystalline silicon layer may be improved.

### BRIEF DESCRIPTION OF THE DRAWINGS

The above and other features of embodiments of the invention will become more apparent by describing in further detail embodiments thereof with reference to the accompanying drawings, in which:

FIGS. 1 and 2 are diagrams illustrating a laser crystallization apparatus according to embodiments of the invention;

FIG. 3 is a cross-sectional view illustrating an embodiment of a display device including a polycrystalline silicon layer manufactured by the laser crystallization apparatus of FIG. 1;

FIG. 4 is a diagram illustrating a laser crystallization apparatus according to an embodiment of the invention;

FIG. 5 is a diagram illustrating a first lens and a second lens included in the laser crystallization apparatus of FIG. 4;

FIGS. 6, 7, and 8 are graphs illustrating a first laser beam, a second laser beam, and a third laser beam included in the laser crystallization apparatus of FIG. 4;

FIG. 9 is a diagram illustrating a laser crystallization apparatus according to another embodiment of the invention;

FIG. 10 is a diagram illustrating a laser crystallization apparatus according to still another embodiment of the invention; and

FIG. 11 is a diagram illustrating a laser crystallization apparatus according to still another embodiment of the invention.

FIG. 12 is a block diagram illustrating an electronic device according to an embodiment of the invention.

FIG. 13 is a schematic diagram of electronic devices.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and

means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with the accompanying drawings.

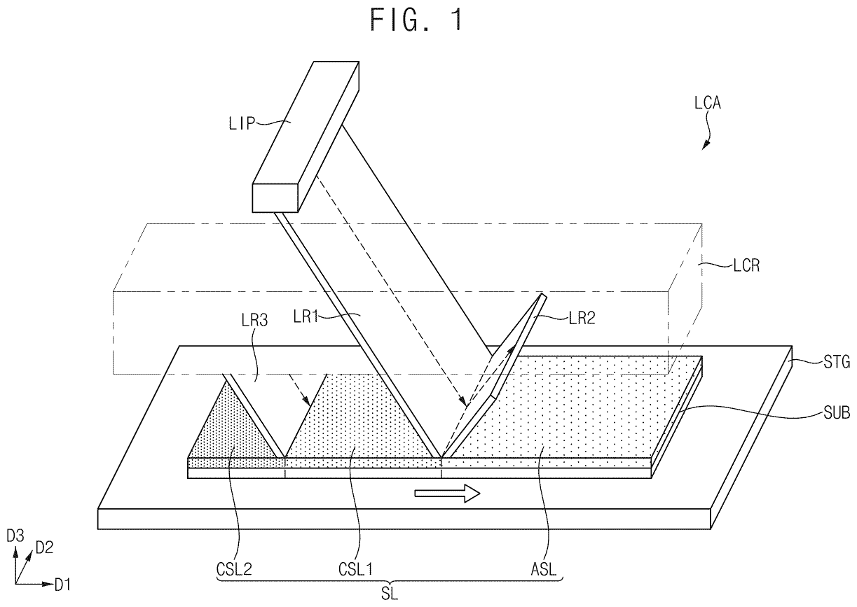

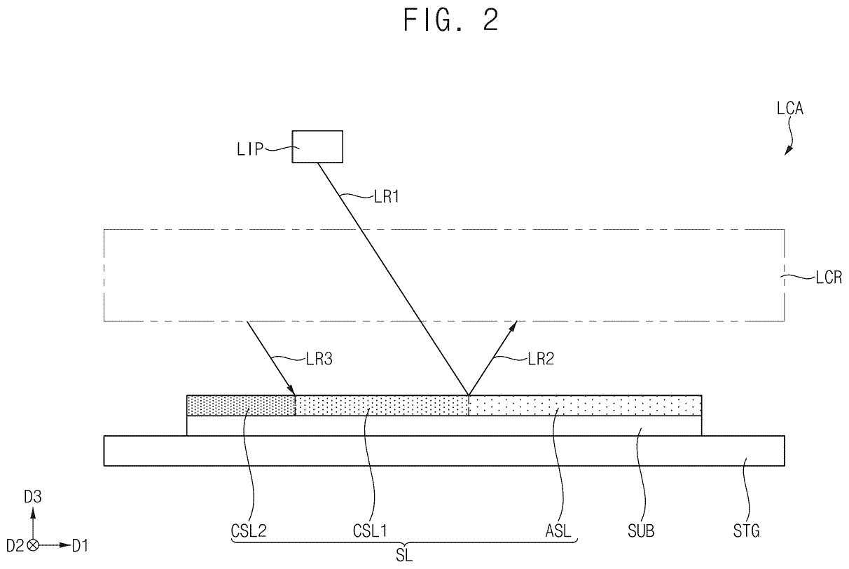

FIGS. 1 and 2 are diagrams illustrating a laser crystallization apparatus according to embodiments of the invention.

Referring to FIGS. 1 and 2, a laser crystallization apparatus LCA according to embodiments of the invention may include a laser irradiation part LIP, a laser controller LCR, and a stage STG. The laser irradiation part LIP may be disposed on the stage STG, and the laser controller LCR may be disposed between the laser irradiation part LIP and the stage STG.

A substrate SUB and a silicon layer SL may be disposed on the stage STG. In an embodiment, the substrate SUB and the silicon layer SL may be moved or moveable in a first direction D1 by the stage STG.

In an embodiment, the laser crystallization apparatus LCA may crystallize the silicon layer SL. In an embodiment, for example, by the laser crystallization apparatus LCA, an amorphous silicon layer ASL may be crystallized into a second polycrystalline silicon layer CSL2 through a first polycrystalline silicon layer CSL1.

In an embodiment, the amorphous silicon layer ASL may be uniformly formed on the substrate SUB using silicon or a silicon-based material through a sputtering process, a reduced pressure chemical vapor deposition (CVD) process, a plasma CVD process, or the like.

The laser irradiation part LIP may radiate a first laser beam LR1. In an embodiment, the first laser beam LR1 may have a predetermined wavelength (e.g., about 300 nanometers (nm)). In an embodiment, for example, the first laser beam LR1 may be a laser beam using an excimer laser, a YAG (yttrium aluminum garnet) laser, a glass laser, a YVO4 (yttrium orthovanadate) laser, an argon laser, or the like.

In an embodiment, the first laser beam LR1 may be output in a trapezoidal or rectangular shape. In an embodiment, for example, the first laser beam LR1 may have a beam width in the first direction D1 and a beam length in a second direction D2 intersecting the first direction D1. Accordingly, the first laser beam LR1 may be evenly radiated onto the substrate SUB.

The laser irradiation part LIP may radiate the first laser beam LR1 to the amorphous silicon layer ASL deposited on the substrate SUB at a predetermined interval while overlapping each other. Accordingly, a process of a temperature of the amorphous silicon layer ASL increases, and the amorphous silicon layer ASL being cooled again is repeated, such that the amorphous silicon can be melted and recrystallized. Accordingly, the first polycrystalline silicon layer CSL1 including polysilicon may be formed.

In an embodiment, the laser controller LCR may receive a second laser beam LR2 and radiate a third laser beam LR3. In an embodiment, for example, the second laser beam LR2 may be a laser beam that is the first laser beam LR1 reflected from the substrate SUB. The laser controller LCR may have a predetermined optical system, and the third laser beam LR3 may be a laser beam that is the second laser beam LR2 passed through the laser controller LCR. In an embodiment, the second laser beam LR2 may be adjusted by the laser controller LCR while passing therethrough. In an embodiment, for example, the laser controller LCR may adjust an intensity of the second laser beam LR2. In an embodiment, an intensity of the third laser beam LR3 may be greater than the intensity of the second laser beam LR2.

The laser controller LCR may radiate the third laser beam LR3 to the first polycrystalline silicon layer CSL1 formed on the substrate SUB at a predetermined interval while overlapping each other. Accordingly, the number of overlapping times at which the laser crystallization apparatus LCA radiates the laser beam can increase, and the margin of the energy of the laser beam can be secured.

In an embodiment, the intensity of the third laser beam LR3 may be substantially the same as the intensity of the first laser beam LR1. In other words, the laser controller LCR may control the third laser beam LR3 in a way such that the intensity of the third laser beam LR3 is substantially the same as the intensity of the first laser beam LR1. Accordingly, the streak defect existing in the first polycrystalline silicon layer CSL1 can be removed, and the reliability of the second polycrystalline silicon layer CSL2 can be improved.

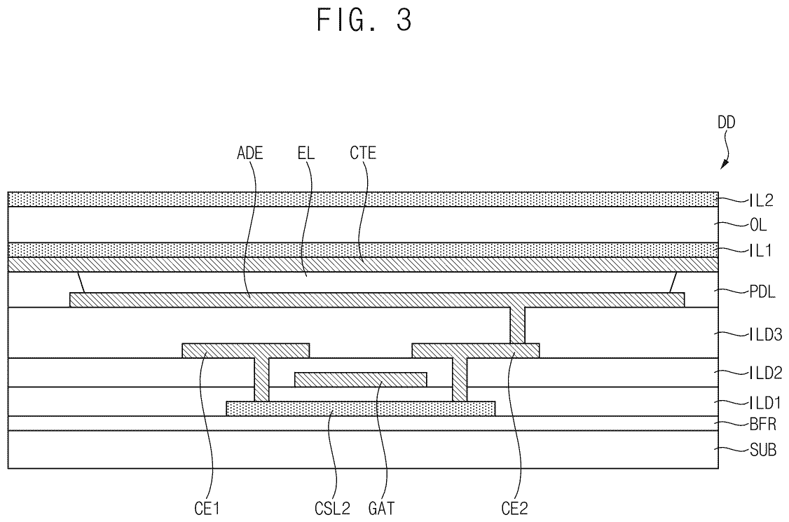

FIG. 3 is a cross-sectional view illustrating an embodiment of a display device including a polycrystalline silicon layer manufactured by the laser crystallization apparatus of FIG. 1.

Referring to FIG. 3, an embodiment of a display device DD including a polycrystalline silicon layer manufactured by the laser crystallization apparatus of FIG. 1 may include a substrate SUB, a buffer layer BFR, an active pattern CSL2, a first insulating layer ILD1, a gate electrode GAT, a second insulating layer ILD2, a first connection electrode CE1, a second connection electrode CE2, a third insulating layer ILD3, a pixel electrode ADE, an emission layer EL, a common electrode CTE, a pixel defining layer PDL, a first inorganic layer IL1, an organic layer OL, and a second inorganic layer IL2.

The substrate SUB may include glass, quartz, plastic, etc. In an embodiment, for example, the substrate SUB may be a plastic substrate and may include polyimide (PI). In an embodiment, the substrate SUB may have a structure in which at least one polyimide layer and at least one barrier layer are alternately laminated.

The buffer layer BFR may be disposed on the substrate SUB. The buffer layer BFR may include silicon oxide, silicon nitride, or the like. The buffer layer BFR may effectively prevent impurities from diffusing into the active pattern CSL2.

The active pattern CSL2 may be disposed on the buffer layer BFR. In an embodiment, for example, the active pattern CSL2 may include polycrystalline silicon. The active pattern CSL2 may pass current or block current based on a gate signal provided to the gate electrode GAT.

The first insulating layer ILD1 may include an insulating material and may cover the active pattern CSL2. In an embodiment, for example, the first insulating layer ILD1 may include silicon oxide, silicon nitride, titanium oxide, tantalum oxide, or the like. The first insulating layer ILD1 may electrically insulate the active pattern CSL2 and the gate electrode GAT.

The gate electrode GAT may include a metal, an alloy, a conductive metal oxide, or the like, and may be disposed on the first insulating layer ILD1. In an embodiment, for example, the gate electrode GAT may include silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), nickel (Ni), chromium (Cr), chromium nitride (CrN), titanium (Ti), tantalum (Ta), platinum (Pt), scandium (Sc), indium tin oxide (ITO), indium zinc oxide (IZO), or the like.

The second insulating layer ILD2 may include an insulating material and may cover the gate electrode GAT. In an embodiment, for example, the second insulating layer ILD2 may include silicon oxide, silicon nitride, titanium oxide, tantalum oxide, or the like. The second insulating layer ILD2 may electrically insulate the gate electrode GAT from the first connection electrode CE1 and electrically insulate the gate electrode GAT from the second connection electrode CE2.

The first connection electrode CE1 and the second connection electrode CE2 may be disposed on the second insulating layer ILD2 and may be connected to the active pattern CSL2.

In an embodiment, the first connection electrode CE1 and the second connection electrode CE2 may include a metal, an alloy, a conductive metal oxide, or the like. In an embodiment, for example, the first and second connection electrodes CE1 and CE2 may include silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), nickel (Ni), chromium (Cr), chromium nitride (CrN), titanium (Ti), tantalum (Ta), platinum (Pt), scandium (Sc), indium tin oxide (ITO), indium zinc oxide (IZO), or the like.

The third insulating layer ILD3 may cover the first and second connecting electrodes CE1 and CE2, may include an organic insulating material, and may have a substantially flat upper surface. In an embodiment, for example, the third insulating layer ILD3 may include a photoresist, a polyacrylic resin, a polyimide resin, an acrylic resin, or the like.

The pixel electrode ADE may be disposed on the third insulating layer ILD3 and may be connected to the second connection electrode CE2. The pixel electrode ADE may receive a first voltage from the second connection electrode CE2.

In an embodiment, the pixel electrode ADE may include a metal, an alloy, a conductive metal oxide, or the like. In an embodiment, for example, the pixel electrode ADE may include silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), nickel (Ni), chromium (Cr), chromium nitride (CrN), titanium (Ti), tantalum (Ta), platinum (Pt), scandium (Sc), indium tin oxide (ITO), indium zinc oxide (IZO), or the like.

The pixel defining layer PDL may be disposed on the via insulating layer VIA, and an opening exposing the upper surface of the pixel electrode ADE may be defined or formed in the pixel defining layer PDL. In an embodiment, for example, the pixel defining layer PDL may include an organic material such as a polyimide-based resin (e.g., a photosensitive polyimide-based resin (PSPI)), a photoresist, a polyacrylic-based resin, an acrylic resin, or an inorganic material such as silicon oxide and silicon nitride.

The emission layer EL may be disposed on the pixel electrode ADE. In an embodiment, the emission layer EL may have a multilayer structure including an organic light-emitting layer, a hole injection layer, a hole transport layer, an electron transport layer, and an electron injection layer.

The common electrode CTE may be disposed on the emission layer EL and may provide a second voltage. The common electrode CTE may include a metal, an alloy, a conductive metal oxide, or the like. In an embodiment, for example, the common electrode CTE may include silver (Ag), an alloy containing silver, molybdenum (Mo), an alloy containing molybdenum, aluminum (Al), an alloy containing aluminum, aluminum nitride (AIN), tungsten (W), tungsten nitride (WN), copper (Cu), nickel (Ni), chromium (Cr), chromium nitride (CrN), titanium (Ti), tantalum (Ta), platinum (Pt), scandium (Sc), indium tin oxide (ITO), indium zinc oxide (IZO), or the like.

By a voltage difference between the first voltage and the second voltage, the

emission layer EL may generate light. Accordingly, the pixel electrode ADE, the emission layer EL and the common electrode CTE may be defined as a light emitting diode.

A thin film encapsulation layer may be disposed on the common electrode CTE. The thin film encapsulation layer may effectively prevent the penetration of moisture and oxygen from the outside. In an embodiment, for example, the thin film encapsulation layer may have a structure in which the first inorganic layer IL1, the organic layer OL, and the second inorganic layer IL2 are alternately laminated.

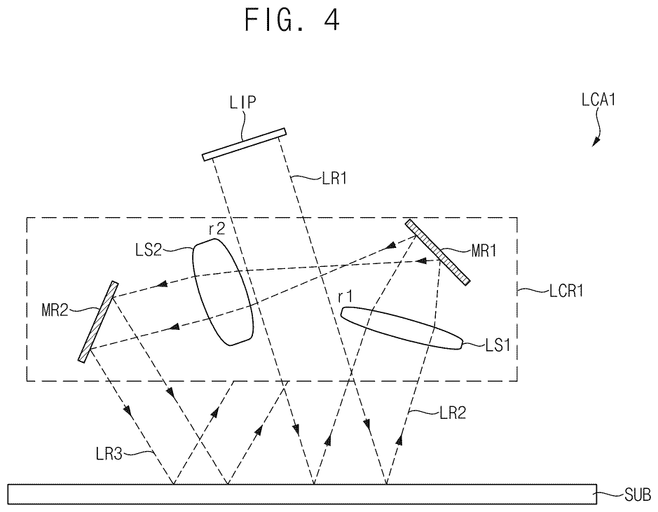

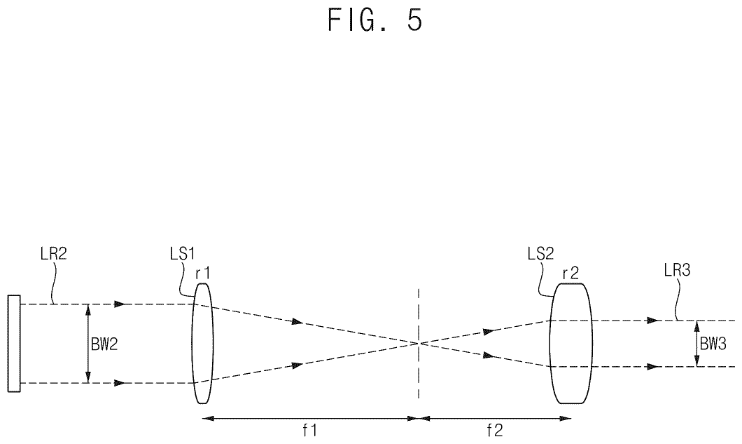

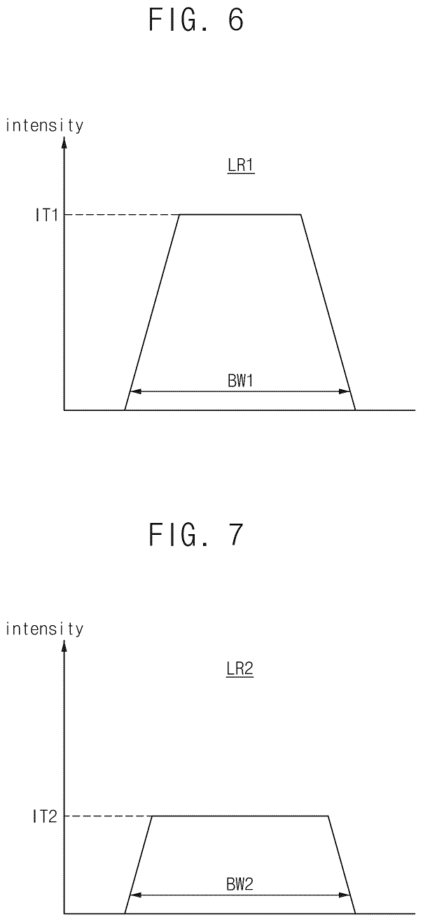

FIG. 4 is a diagram illustrating a laser crystallization apparatus according to an embodiment of the invention. FIG. 5 is a diagram illustrating a first lens and a second lens included in the laser crystallization apparatus of FIG. 4. FIGS. 6, 7, and 8 are graphs illustrating a first laser beam, a second laser beam, and a third laser beam included in the laser crystallization apparatus of FIG. 4.

Referring to FIG. 4, a laser crystallization apparatus LCA1 according to an embodiment of the invention may include a laser irradiation part LIP and a laser controller LCR1. The laser irradiation part LIP may be substantially the same as the laser irradiation part LIP described above with reference to FIGS. 1 and 2.

In an embodiment, the laser controller LCR1 may include a first lens LS1, a first mirror MR1, a second lens LS2, and a second mirror MR2. In an embodiment, each of the first lens LS1 and the second lens LS2 may be a telescope lens, for example. Accordingly, the first lens LS1 and the second lens LS2 may refract and transmit a laser beam incident thereon. The first mirror MR1 and the second mirror MR2 may reflect a laser beam incident thereon.

The laser controller LCR1 may receive the second laser beam LR2 and may radiate the third laser beam LR3 using the first lens LS1, the first mirror MR1, the second lens LS2, and the second mirror MR2. In an embodiment, for example, the laser controller LCR1 may generate the third laser beam LR3 using the first lens LS1 and the second lens LS2, and may radiate the third laser beam LR3 onto the substrate SUB using the first mirror MR1 and the second mirror MR2.

In an embodiment, the laser beam may sequentially travel through the first lens LS1, the first mirror MR1, the second lens LS2, and the second mirror MR2. In an embodiment, for example, the first lens LS1 may be disposed between the substrate SUB and the first mirror MR1, and the second lens LS2 may be disposed between the first mirror MR1 and the second mirror MR2.

However, the invention is not limited thereto. In an embodiment, the first lens LS1 and the second lens LS2 may adjust the beam width and intensity of the laser beam, and the first mirror MR1 and the second mirror MR2 may adjust the direction of the laser beam. Accordingly, the arrangement of the first lens LS1 and the second lens LS2, and the first mirror MR1 and the second mirror MR2 may be appropriately set based on the beam width, intensity, and direction of the third laser beam LR3.

Referring to FIG. 5, in an embodiment, the first lens LS1 may have a first focal length f1. In an embodiment, for example, the first lens LS1 may have a predetermined thickness, and an incident surface and an exit surface of the first lens LS1 may be convex. The first lens LS1 may have a first curvature radius r1.

In an embodiment, the second lens LS2 may have a second focal length f2. In an embodiment, for example, the second lens LS2 may have a predetermined thickness, and an incident surface and an exit surface of the second lens LS2 may be convex. The second lens LS2 may have a second curvature radius r2.

In an embodiment, a distance between the first lens LS1 and the second lens LS2 (i.e., a beam travel distance from the first lens LS1 to the second lens LS2 via the first mirror MR1 as shown in FIG. 5) may be substantially the same as a sum of the first focal length f1 and the second focal length f2.

In an embodiment, the first focal length f1 may be different from the second focal length f2. In an embodiment, for example, the first focal length f1 may be greater than the second focal length f2. In other words, the first curvature radius r1 may be greater than the second curvature radius r2.

Referring to FIGS. 6, 7, and 8, as shown in FIG. 6, the first laser beam LR1 may have a first beam width BW1 and a first intensity IT1.

As shown in FIG. 7, the second laser beam LR2 may have a second beam width BW2 and a second intensity IT2. In this case, as the first laser beam LR1 is reflected from the substrate SUB, the second intensity IT2 may be less than the first intensity IT1. The second beam width BW2 may be substantially the same as the first beam width BW1.

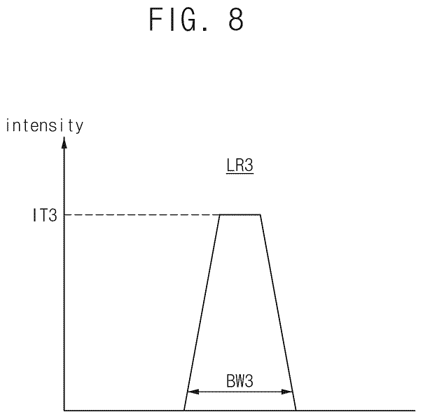

As shown in FIG. 8, the third laser beam LR3 may have a third beam width BW3 and a third intensity IT3. In this case, as the second laser beam LR2 travels through the laser controller LCR1, the third intensity IT3 may increase. In other words, the third intensity IT3 may be greater than the second intensity IT2. In an embodiment, for example, the third intensity IT3 may be substantially the same as the first intensity IT1. In addition, the third beam width BW3 may be less than the second beam width BW2.

Referring back to FIG. 5, the second laser beam LB2 reflected from the substrate SUB may pass through the first lens LS1 and the second lens LS2.

As described above, the first lens LS1 may have the first focal length f1, the second lens LS2 may have the second focal length f2, and the distance between the first lens LS1 and the second lens LS2 may be substantially the same as the sum of the first and second focal lengths f1 and f2.

Accordingly, the ratio between the second beam width BW2 and the third beam width BW3 may correspond to the ratio between the first focal length f1 and the second focal length f2. In an embodiment, for example, the ratio between the second beam width BW2 and the third beam width BW3 may be substantially the same as the ratio between the first focal length f1 and the second focal length f2.

The ratio between the third intensity IT3 and the second intensity IT2 may correspond to the ratio between the second beam width BW2 and the third beam width BW3. In an embodiment, for example, the ratio between the third intensity IT3 and the second intensity IT2 may be substantially same as the ratio between the second beam width BW2 and the third beam width BW3. In other words, the ratio between the third intensity IT3 and the second intensity IT2 may be substantially the same as the ratio between the first focal length f1 and the second focal length f2.

Therefore, by setting the ratio between the first and second focal lengths f1 and f2, the third intensity IT3 may be adjusted. In an embodiment, for example, the first intensity IT1 and the second intensity IT2 may be measured, and the ratio between the first and second focal lengths f1 and f2 may be set to be the same as the ratio between the first and second intensities IT1 and IT2. In such an embodiment, the second intensity IT2 reduced by the first and second lenses LS1 and LS2 may be compensated, and the third laser beam LR3 may have the third intensity IT3 substantially the same as the first intensity IT1.

In an embodiment, for example, the first laser beam LR1 may have a wavelength of about 300 nm and may have a first beam width BW1 of about 500 nm.

The second laser beam LR2 reflected from the substrate SUB from the first laser beam LR1 may have a second beam width BW2 of about 500 nm, which is substantially the same as the first beam width BW1. The second intensity IT2 may be in a range of about 0.5 to 0.6 times (e.g., about 0.54 times) of the first intensity IT1. In other words, a ratio of the second intensity IT2 to the first intensity IT1 may be in a range of about 0.5 to about 0.6 (e.g., about 0.54).

The second laser beam LR2 may be incident on the laser controller LCR1. The laser controller LCR1 may have the first lens LS1 and the second lens LS2, and a ratio between the first focal length f1 and the second focal length f2 may be in a range of about 0.5 to about 0.6 (e.g., about 0.54).

The third laser beam LR3 may have a third beam width BW3 less than the second beam width BW2. A ratio of the third beam width BW3 to the second beam width BW2 may be in a range of about 0.5 to about 0.6 (e.g., about 0.54). In an embodiment, for example, the second beam width BW2 may be about 500 nm, and the third beam width BW3 may be about 270 nm.

As the third beam width BW3 decreases, the third intensity IT3 may increase. Accordingly, the third intensity IT3 may be greater than the second intensity IT2 and substantially the same as the first intensity IT1. In an embodiment, for example, a ratio of the second intensity IT2 to the third intensity IT3 may be in a range of about 0.5 to about 0.6 (e.g., about 0.54).

In an embodiment, the first laser beam LR1 and the third laser beam LR3 may not intersect each other. Accordingly, the first laser beam LR1 and the third laser beam LR3 may be radiated with a time difference to a predetermined area of the substrate SUB.

A laser crystallization apparatus LCA according to an embodiment of the invention may include the laser irradiation part LIP and the laser controller LCR1. The laser controller LCR1 may control a laser beam and re-incident it onto the substrate SUB. Accordingly, the number of overlapping times for radiating the laser beam may increase, and the energy margin of the laser beam may be secured.

In such an embodiment, the laser controller LCR1 may reduce the beam width of the laser beam to increase the intensity of the laser beam. By increasing the intensity of the re-incident laser beam, the streak defect existing in the polycrystalline silicon layer can be removed.

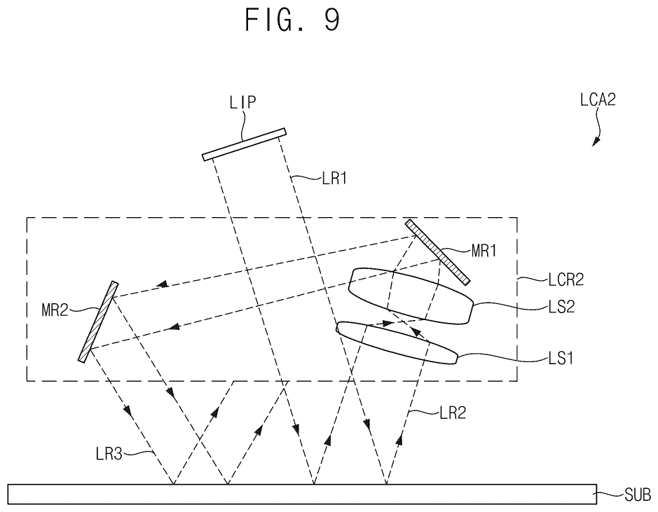

FIG. 9 is a diagram illustrating a laser crystallization apparatus according to another embodiment of the invention.

Referring to FIG. 9, a laser crystallization apparatus LCA2 according to another embodiment of the invention may include a laser irradiation part LIP and a laser controller LCR2. The laser irradiation part LIP may be substantially the same as the laser irradiation part LIP described above with reference to FIGS. 1 and 2.

In an embodiment, the laser controller LCR2 may include a first lens LS1, a second lens LS2, a first mirror MR1, and a second mirror MR2. As described above, the first lens LS1 and the second lens LS2 may have a first focal length and a second focal length, respectively, and a distance between the first lens LS1 and the second lens LS2 (i.e., a beam travel distance from the first lens LS1 to the second lens LS2 as shown in FIG. 5) may be substantially the same as a sum of the first and second focal lengths.

In an embodiment, the laser beam may sequentially travel through the first lens LS1, the second lens LS2, the first mirror MR1, and the second mirror MR2. In an embodiment, for example, the first lens LS1 may be disposed between the substrate SUB and the second lens LS2, and the second lens LS2 may be disposed between the first lens LS1 and the first mirror MR1.

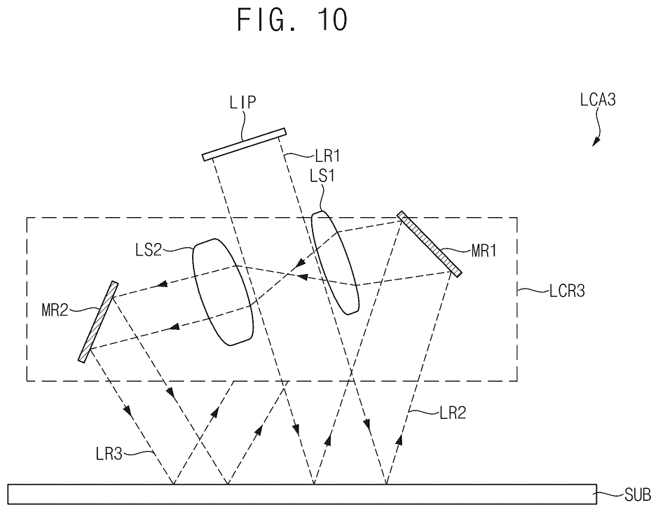

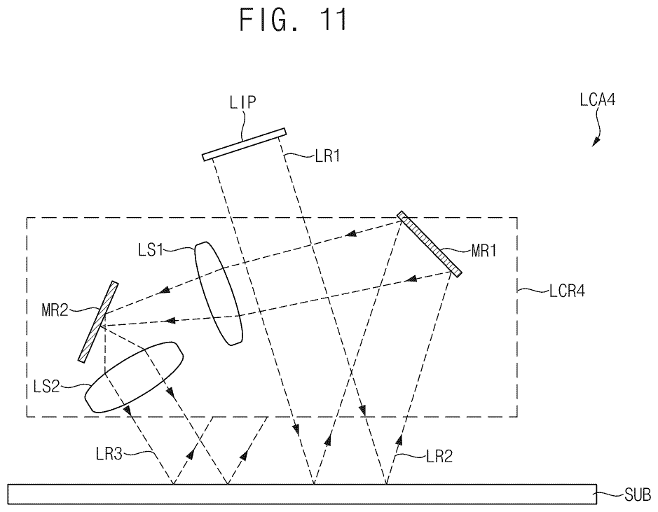

FIG. 10 is a diagram illustrating a laser crystallization apparatus according to still another embodiment of the invention.

Referring to FIG. 10, a laser crystallization apparatus LCA3 according to still another embodiment of the invention may include a laser irradiation part LIP and a laser controller LCR3. The laser irradiation part LIP may be substantially the same as the laser irradiation part LIP described above with reference to FIGS. 1 and 2.

In an embodiment, the laser controller LCR3 may include a first mirror MR1, a first lens LS1, a second lens LS2, and a second mirror MR2. In such an embodiment, as described above, the first lens LS1 and the second lens LS2 may have a first focal length and a second focal length, respectively, and a distance between the first lens LS1 and the second lens LS2 (i.e., a beam travel distance from the first lens LS1 to the second lens LS2 as shown in FIG. 5) may be substantially the same as a sum of the first and second focal lengths.

In an embodiment, the laser beam may sequentially travel through the first mirror MR1, the first lens LS1, the second lens LS2, and the second mirror MR2. In an embodiment, for example, the first lens LS1 may be disposed between the first mirror MR1 and the second lens LS2, and the second lens LS2 may be disposed between the first lens LS1 and the second mirror MR2.

FIG. 11 is a diagram illustrating a laser crystallization apparatus according to still another embodiment of the invention.

Referring to FIG. 11, a laser crystallization apparatus LCA4 according to still another embodiment of the invention may include a laser irradiation part LIP and a laser controller LCR4. The laser irradiation part LIP may be substantially the same as the laser irradiation part LIP described above with reference to FIGS. 1 and 2.

In an embodiment, the laser controller LCR4 may include a first mirror MR1, a first lens LS1, a second mirror MR2, and a second lens LS2. In such an embodiment, as described above, the first lens LS1 and the second lens LS2 may have a first focal length and a second focal length, respectively, and a distance between the first lens LS1 and the second lens LS2 (i.e., a beam travel distance from the first lens LS1 to the second lens LS2 as shown in FIG. 5) may be substantially the same as a sum of the first and second focal lengths.

In an embodiment, the laser beam may sequentially travel through the first mirror MR1, the second mirror MR2, the first lens LS1, and the second lens LS2. In an embodiment, for example, the first lens LS1 may be disposed between the first mirror MR1 and the second mirror MR2, and the second lens LS2 may be disposed between the second mirror MR2 and the substrate SUB.

The display device DD according to embodiments may be applied to various electronic devices. An electronic device according to an embodiment may include the display device DD described above, and may further include a module or device having additional functions in addition to the display device DD.

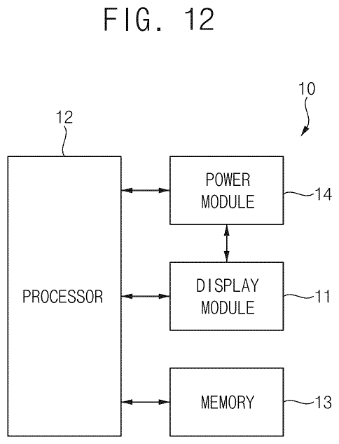

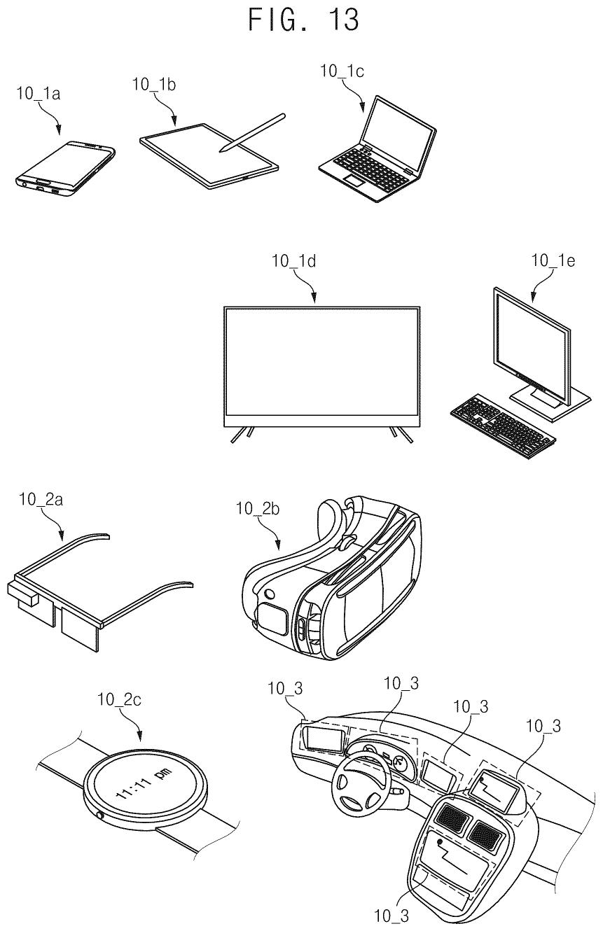

FIG. 12 is a block diagram illustrating an electronic device according to an embodiment of the invention.

Referring to FIG. 12, an electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data information necessary for an operation of the processor 12 or the display module 11. When the processor 12 executes an application stored in the memory 13, an image data signal and/or an input control signal may be transmitted to the display module 11, and the display module 11 may process the received signal and output image information through a display screen.

The power module 14 may include a power supply module such as a power adapter, a battery device, or the like and a power conversion module that converts power supplied by the power supply module to generate power necessary for an operation of the electronic device 10.

At least one of the components of the electronic device 10 described above may be included in the display device according to embodiments described above. In addition, some of individual modules functionally included in one module may be included in the display device, and others may be provided separately from the display device. For example, the display device may include the display module 11, and the processor 12, the memory 13, and the power module 14 may be provided in form of other devices in the electronic device 10 other than the display device.

FIG. 13 is a schematic diagram of electronic devices.

Referring to FIG. 13, various electronic devices to which the display device according to embodiments are applied may include not only an image display electronic device, but also a wearable electronic device including a display module, a vehicle electronic device 10_3 including a display module, or the like. The image display electronic device may be a smartphone 10_1a, a tablet PC 10_1b, a laptop 10_1c, a TV 10_1d, a desk monitor 10_1e, or the like. The wearable electronic device may be smart glasses 10_2a, a head mounted display 10_2b, a smart watch 10_2c, or the like. The vehicle electronic device 10_3 may be a center information display (CID) disposed on a dashboard and center fascia of a vehicle, a room mirror display, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A laser crystallization apparatus comprising:
a laser irradiation part which radiates a first laser beam to a substrate; and
a laser controller which receives a second laser beam, wherein the laser controller includes a first lens having a first focal length and a second lens having a second focal length different from the first focal length, and the laser controller radiates a third laser beam,
wherein the second laser beam is the first laser beam reflected from the substrate, and
the third laser beam is the second laser beam passed through the laser controller, wherein an intensity of the second laser beam is adjusted by the laser controller.

2. The laser crystallization apparatus of claim 1, wherein an intensity of the third laser beam is substantially the same as an intensity of the first laser beam.

3. The laser crystallization apparatus of claim 1, wherein a ratio between the first focal length and the second focal length corresponds to a ratio between the intensity of the second laser beam and an intensity of the third laser beam.

4. The laser crystallization apparatus of claim 3, wherein the first focal length is greater than the second focal length.

5. The laser crystallization apparatus of claim 4, wherein a ratio of the second focal length to the first focal length is in a range of about 0.5 to about 0.6.

6. The laser crystallization apparatus of claim 3, wherein the intensity of the second laser beam is less than an intensity of the third laser beam.

7. The laser crystallization apparatus of claim 6, wherein a ratio of an intensity of the second laser beam to an intensity of the third laser beam is in a range of about 0.5 to about 0.6.

8. The laser crystallization apparatus of claim 3, wherein a beam width of the second laser beam is greater than a beam width of the third laser beam.

9. The laser crystallization apparatus of claim 8, wherein a ratio of the beam width of the third laser beam to the beam width of the second laser beam is in a range of about 0.5 to about 0.6.

10. The laser crystallization apparatus of claim 1, wherein a first curvature radius of the first lens is greater than a second curvature radius of the second lens.

11. The laser crystallization apparatus of claim 1, wherein the first laser beam and the third laser beam do not intersect each other.

12. The laser crystallization apparatus of claim 1, wherein each of the first lens and the second lens is a telescope lens.

13. The laser crystallization apparatus of claim 1, wherein the laser controller further includes:
a first mirror and a second mirror which reflect the second laser beam.

14. The laser crystallization apparatus of claim 13, wherein a laser beam sequentially travels through the first lens, the first mirror, the second lens, and the second mirror.

15. The laser crystallization apparatus of claim 13, wherein a laser beam sequentially travels through the first lens, the second lens, the first mirror, and the second mirror.

16. The laser crystallization apparatus of claim 13, wherein a laser beam sequentially travels through the first mirror, the first lens, the second lens, and the second mirror.

17. The laser crystallization apparatus of claim 13, wherein a laser beam sequentially travels through the first mirror, the first lens, the second mirror, and the second lens.

18. The laser crystallization apparatus of claim 1, wherein the first laser beam crystallizes an amorphous silicon layer disposed on the substrate.
